(19) United States
(12) Patent Application Publication
(10) Pub. No.: US 2012/0240643 A1
(43) Pub. Date: Sep. 27, 2012

(54) ELECTRONIC CONTROLLER FOR A LOCKING DEVICE AND STEERING WHEEL LOCK

(75) Inventor: Stefan Kleineberg, Rodgau (DE)

(73) Assignee: CONTINENTAL AUTOMOTIVE GMBH, Hannover (DE)

(21) Appl. No.: 13/514,350

(22) PCT Filed: Nov. 3, 2010
(86) PCT No.: PCT/EP10/66678

§ 371 Date: Jun. 7, 2012

(30) Foreign Application Priority Data
Dec. 16, 2009 (DE) 10 2009 054 748.7

(51) Int. Cl. B60R 25/02; H01H 47/00; E05B 47/00

(52) U.S. Cl. 70/207; 361/139

(57) ABSTRACT

An electronic controller for a locking device. The controller has an actuation unit having at least two switchable control states for actuating an electromechanical actuator, wherein the locking device can be locked in the first control state by the actuator and can be released in the second control state. The controller has a first deactivation device which is arranged upstream of the actuation unit in the signal flow and is configured in such a way that only the first control state can be blocked by the first deactivation device and the second control state cannot be influenced by the first deactivation device. The invention also relates to a steering wheel lock having a latching element, a counter-latching element in the force flux of a steering system and an electromechanical actuator which can move the latching element into engagement with the counter-latching element and is actuated by the described electronic controller.

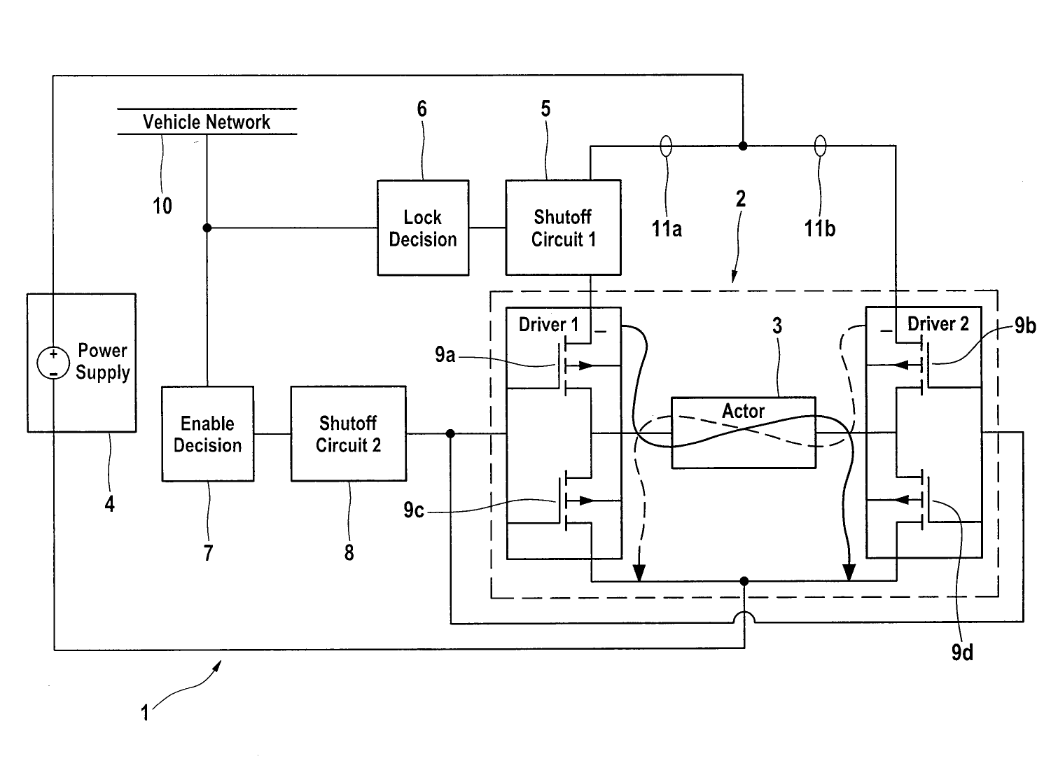

### CROSS REFERENCE TO RELATED APPLICATIONS

This application is the U.S. National Phase Application of PCT/EP2010/066678, filed Nov. 3, 2010, which claims priority to German Patent Application No. 10-2009-054 748.7, filed Dec. 16, 2009, the contents of such applications being incorporated by reference herein.

### FIELD OF THE INVENTION

The invention relates to an electronic controller for a locking device and to a steering wheel lock having a corresponding controller.

### BACKGROUND OF THE INVENTION

Locking devices, in particular steering wheel locks in motor vehicles, have to satisfy certain safety requirements in order to prevent undesired locking in critical situations. This is because undesired locking of a steering wheel lock can lead to driving situations which are critical for safety and which a driver can no longer cope with. Specified safety requirements are defined, for example, by the so-called safety integrity level (SIL), or in the field of automobiles by safety requirement stages, the so-called Automotive Safety Integrity Level (ASIL).

### BRIEF DESCRIPTION OF THE INVENTION

An aspect of the invention is to provide a controller for a locking device which ensures a simple functionality and nevertheless a high degree of safety. In addition, an object of the invention is to provide a steering wheel lock with such a controller.

In a first aspect, this is achieved by an electronic controller for a locking device, comprising
an actuation unit having at least two switchable control states for actuating an electromechanical actuator, wherein the locking device can be locked in the first control state by means of the actuator and can be released in the second control state,
a voltage supply for operating the actuator in the first or in the second control state of the actuation unit, and
a first deactivation device which is arranged upstream of the actuation unit in the signal flow and is configured in such a way that only the first control state can be blocked by means of the first deactivation device and the second control state cannot be influenced by means of the first deactivation device.

Such an electronic controller has the advantage that when a safety-critical control state is blocked, further functions of the controller continue to be available. Specifically, this means that only activation of an actuator for the purpose of locking a locking device is prevented, but not activation of the actuator for the purpose of releasing a locked locking device. As a result, the controller ensures a high degree of protection against safety-critical locking of a locking device.

The controller is preferably configured in such a way that when the first control state is blocked by the first deactivation device, the second control state is automatically assumed. This means that when a safety-critical situation occurs, a control state is automatically assumed in order to enable a locking device. This ensures that the locking device can be enabled by the controller in this case if a hazardous situation occurs.

The first deactivation device is preferably arranged electrically between the voltage supply and the actuation unit in a supply path for the first control state. The first deactivation device can disconnect the supply path for the first control state in the actuation unit here and therefore interrupt a voltage supply of the actuation unit for the first control state. This ensures that the first control state is blocked in an easy but reliable way.

The controller preferably has a switching control unit for switching the first control state of the actuation unit. A predefined control signal, which is used for the defined setting of the first control state, can be generated by means of the switching control unit.

The switching control unit is preferably arranged electrically upstream of the first deactivation device in such a way that the first deactivation device can be controlled by means of the switching control unit. This means that disconnection of the supply path for the first control state can be controlled by the first deactivation device by means of the switching control unit.

The controller preferably has an enabling unit for enabling the control of the first and second control states of the actuation unit. The enabling unit can determine, by means of an enabling signal, whether or not the control states can be actuated at all. The enabling unit therefore constitutes a further safety device. However, the enabling unit is not responsible for specific control operations of the first or the second control state.

The controller preferably has a second deactivation device which is arranged electrically in the signal flow between the enabling unit and the actuation unit in such a way that the second deactivation device can be controlled by means of the enabling unit. The second deactivation device constitutes, in addition to the specified first deactivation device, a further emergency deactivation means, wherein the actuation unit can as a result be entirely deactivated. Neither the first nor the second control state can then be actuated.

The actuation unit is preferably embodied as an H-bridge circuit with four switching elements, wherein at least the first and second control states can be set by switching on in each case two corresponding switching elements. Such an embodiment of the control unit permits easy implementation of a four-quadrant chopper, which generates different operating states of an electromechanical actuator.

A second aspect is a steering wheel lock, comprising
a latching element,
a counter-latching element in the force flux of a steering system,
an electromechanical actuator which is configured to bring about a latching connection of the latching element to the counter-latching element with the result that a steering movement is blocked, or to cancel said latching connection with the result that a steering movement is enabled, and
an electronic controller of the described type which is connected to the actuator for the purpose of actuation.

The steering wheel lock constitutes a specific embodiment of a locking device which is actuated by means of the above-mentioned controller. In this context, the latching element can be moved, by means of the actuator, into engagement with the counter-latching element which is arranged in the force flux between a steering wheel and the steered wheels of a steering system. In particular during the application of the controller to the control of the steering wheel lock, the high degree of safety of the controller is particularly advantageously utilized by virtue of the specified measures. It is therefore ensured that the steering wheel lock cannot be activated when a critical situation occurs. Such a controlled steering wheel lock therefore constitutes a simple solution which nevertheless prevents undesired locking to a high degree, thereby satisfying a high safety level (SIL-3 or ASIL-D).

### BRIEF DESCRIPTION OF THE DRAWING

The invention will be described below on the basis of an exemplary embodiment in a FIGURE.

### DETAILED DESCRIPTION

The FIGURE shows the controller 1 which has an actuation unit 2. The actuation unit 2 is characterized by a dashed box and comprises in this embodiment two components (driver 1 and driver 2) which each have two switching elements. In the FIGURE, the switching elements 9a and 9c of the component driver 1 and the switching elements 9b and 9d of the component driver 2 are assigned to the actuation unit 2. All the switching elements 9a, 9b, 9c and 9d are connected to form an H-bridge which functions as a four-quadrant chopper for actuating an actuator 3. The switching elements 9a, 9b, 9c and 9d are embodied, for example, as field-effect transistors (MOSFETs). The actuator 3 may be, for example, an electric motor, in particular a direct current motor, or else an electromagnet.

In addition, the entire actuation unit 2 is supplied with electrical energy via a voltage supply 4. In particular, two supply paths 11a and 11b open into the control unit 2, wherein the supply path 11a supplies the component driver 1, and the supply path 11b supplies the component driver 2. The method of functioning of a first deactivation device 5 (Shutoff Circuit 1), which is arranged electrically upstream of the actuation unit 2 in the supply path 11a, will be explained in more detail later.

By switching on the two switching elements 9a and 9d, a first control state can be set, wherein an electric current flows through the actuator 3 to the switching element 9d via the switching element 9a. This control state is represented by a continuous arrow. A second control state can be generated by switching on the two switching elements 9b and 9c, wherein in this case an electric current flows from the switching element 9b in the reverse direction through the actuator 3 to the switching element 9c. This current path is represented by a dashed arrow. Depending on whether the first or the second control state is set, a corresponding operating mode of the actuator 3 is predefined. A latching element of a locking device may be driven here, for example, by electric motor or electromagnetically, with the result that a latching connection of the latching element to a counter-latching element is brought about or released.

The method of functioning of the specified first deactivation device 5, which is arranged electrically upstream of the actuation unit 2 in the supply path 11a, will be described below. The first deactivation device 5 constitutes an emergency deactivation means, wherein the supply path 11a can be disconnected, with the result of preventing a voltage supply to the component driver 1 of the actuation unit 2, in particular a voltage supply to the switching element 9a. The disconnection of the supply path 11a by the first deactuation device 5 can be implemented in the simplest case by opening a switch in the first deactuation device 5. Such a controllable switch can be produced by means of any type of semiconductor switch, for example a bipolar transistor or a MOSFET.

An interruption in the voltage supply in the first supply path 11a results in the switching element 9a no longer being able to be placed in a conductive state with the result that it remains currentless. A consequence of this is that the described first control state cannot be assumed in the direction of the continuous arrow. The first control state is therefore blocked by the first deactuation device 5.

However, since the second supply path 11b to the component driver 2 of the actuation unit 2 remains uninfluenced by the first deactuation device 5, the switching of the actuation unit 2 into the second control state is still possible. The actuator 3 can therefore continue to be operated by a current flow in the direction of the dashed arrow. This means that it is still possible to release a locking device by means of the actuator 3, while locking is blocked. This behavior is particularly advantageous, in particular, when the illustrated controller 1 is applied in a steering wheel lock of a motor vehicle.

A switching control unit 6 (Lock Decision) is connected electrically upstream of the first deactuation device 5. The switching control unit 6 is addressed and controlled here via a control bus 10 (Vehicle Network), with the result that corresponding control instructions can be passed on to the switching control unit 6. The switching control unit 6 ultimately derives, from one or more signals of the control bus 10, a control signal which is passed on to the first deactivation device 5 in order to actuate it. It is therefore possible, via the control signal of the switching control unit 6 in connection with the first deactivation device 5, to disconnect the first supply path 11a or close it and to block or switch on the supply voltage of the switching element 9a in order to generate the first control state.

In addition to the previously mentioned components, the controller 1 also has an enabling unit 7 (Enable Decision) as well as a second deactivation device 8 which is connected electrically downstream (Shutoff Circuit 2). The enabling unit 7 is addressed via the control bus 10 and is basically configured to order the enabling of the control of the switching elements 9a, 9b, 9c and 9d of the actuation unit 2 by means of an enabling signal. For this purpose, the enabling unit 7 derives an enabling signal from one or more signals of the control bus 10. If such an enabling signal is present at the actuation unit 2, the switching elements 9a, 9b, 9c and 9d can be actuated at their control inputs, for example by means of a control unit (not illustrated). Otherwise, actuation of the switching elements 9a, 9b, 9c and 9d has no effect. This means that without enabling the enabling unit 7, neither of the two indicated control states can be brought about at the actuator 3.

The second deactuation device 8, which is connected electrically downstream of the enabling unit 7, is actuated by means of the enabling signal of the enabling unit 7, in order to trigger or block enabling of the control of the switching elements 9a, 9b, 9c and 9d of the actuation unit 2. In this context, the second deactuation device 8 can, in the simplest case, be embodied as a switch which closes the signal lines between the enabling unit 7 and the actuation unit 2 or disconnects them for the purpose of emergency deactivation.

When the controller 1 is applied in the field of automobiles for actuating a steering wheel lock, the control bus 10 can be integrated into an on-board power system and constitute, for example, a CAN bus (CAN=Controller Area Network) or any other type of a vehicle bus system or any desired control signal.

It is conceivable to provide such a controller 1 for controlling any locking device in which an electromagnetic actuator is used and in which at least one safety signal is provided which decides whether or not it is permitted to lock the locking device. The embodiment of all the switching elements 9a, 9b, 9c and 9d is selected here only by way of example. It is certainly conceivable to use any type of switching elements, in particular power semiconductor components.

The switching control unit 6 and the enabling unit 7 can be embodied either as hardware components or as software components or as a combination of hardware and software.

### LIST OF REFERENCE NUMBERS

1 controller
2 actuation unit
3 actuator
4 voltage supply
5 first deactuation device
6 switching control unit
7 enabling unit
8 second deactuation device
9a, 9b, 9c, 9d switching element
10 control bus
11a, 11b supply path

1.-9. (canceled)

10. An electronic controller for a locking device, comprising:
an actuation unit having at least two switchable control states for actuating an electromechanical actuator, wherein the locking device can be locked in a first control state by the actuator and can be released in a second control state;
a voltage supply for operating the actuator in the first or in the second control state of the actuation unit; and
a first deactivation device which is arranged upstream of the actuation unit in the signal flow and is configured in such a way that only the first control state can be blocked by the first deactivation device and the second control state cannot be influenced by the first deactivation device.

11. The electronic controller as claimed in claim 10, which is configured in such a way that when the first control state is blocked by the first deactivation device, the second control state is automatically assumed.

12. The electronic controller as claimed in claim 10, wherein the first deactivation device is arranged electrically between the voltage supply and the actuation unit in a supply path for the first control state.

13. The electronic controller as claimed in claim 10, further comprising a switching control unit for switching the first control state of the actuation unit.

14. The electronic controller as claimed in claim 13, wherein the switching control unit is arranged electrically upstream of the first deactivation device in such a way that the first deactivation device can be controlled by the switching control unit.

15. The electronic controller as claimed in claim 10, further comprising an enabling unit for enabling the control of the first and second control states of the actuation unit.

16. The electronic controller as claimed in claim 15, further comprising a second deactivation device which is arranged electrically in the signal flow between the enabling unit and the actuation unit in such a way that the second deactivation device can be controlled by the enabling unit.

17. The electronic controller as claimed in claim 10, wherein the actuation unit is embodied as an H-bridge circuit with four switching elements, and at least the first and second control states can be set by switching on in each case two corresponding switching elements.

18. A steering wheel lock, comprising:
a latching element;
a counter-latching element in a force flux of a steering system;
an electromechanical actuator which is configured to bring about a latching connection of the latching element to the counter-latching element with the result that a steering movement is blocked, or to cancel said latching connection with the result that a steering movement is enabled; and
an electronic controller as claimed in claim 10 which is connected to the actuator for the purpose of actuation.
